(19) United States
(12) Patent Application Publication
(10) Pub. No.: US 2014/0279178 A1
(43) Pub. Date: Sep. 18, 2014

(54) METHOD, APPARATUS, AND MEDIA FOR CONNECTING VENDORS WITH CUSTOMERS THROUGH A VIRTUAL INTERFACE

(71) Applicant: EMERALD GAMES MARKETING LIMITED, DUBLIN 2 (IE)

(72) Inventors: Charles L. Harman, Abbottstown, PA (US); Gerard Christopher Klug, Gibsonia, PA (US)

(73) Assignee: EMERALD GAMES MARKETING LIMITED, DUBLIN 2 (IE)

(21) Appl. No.: 14/218,844

(22) Filed: Mar. 18, 2014

Related U.S. Application Data
(63) Continuation-in-part of application No. 14/139,606, filed on Dec. 23, 2013.
(60) Provisional application No. 61/789,940, filed on Mar. 15, 2013.

(51) Int. Cl. G06Q 30/06

(52) U.S. Cl. CPC G06Q 30/0611
USPC 705/26.4

(57) ABSTRACT

The disclosed embodiment relates to connecting real-world vendors with customers through a virtual game environment using a computer-implemented method, an apparatus comprising one or more processors and one or more memories operatively coupled to at least one of the one or more processors, and at least one non-transitory computer-readable medium storing computer-readable instructions. An exemplary method includes receiving information from a user regarding a desired product or service, presenting a virtual game environment based at least in part on the desired product or service, monitoring the user's activity in the virtual game environment, providing an offer to the user corresponding to the desired product or service, the offer being based at least in part on the user's activity in the virtual game environment, and providing information identifying a real-world vendor corresponding to the offer, thereby enabling interactions between the user and the real-world vendor.

### RELATED CASE INFORMATION

This application is a continuation-in-part of U.S. application Ser. No. 14/139,606, filed Dec. 23, 2013, and further claims priority to U.S. Provisional No. 61/789,940, filed Mar. 15, 2013, the disclosures of which are incorporated by reference in their entireties.

### FIELD OF THE INVENTION

The invention relates to a method and apparatus for connecting vendors with customers through a virtual interface.

### SUMMARY OF THE INVENTION

As described herein, the disclosed embodiment relates to a computer-implemented method executed by one or more computing devices for connecting customers with real-world vendors through a virtual game environment. An exemplary method includes receiving, through a virtual interface, information from a user regarding a desired product or service, presenting, through a virtual interface, a virtual game environment based at least in part on the desired product or service, monitoring the user's activity in the virtual game environment, providing, through the virtual interface, an offer to the user corresponding to the desired product or service, the offer being based at least in part on the user's activity in the virtual game environment, and providing, through the virtual interface, information identifying at least one real-world vendor corresponding to the offer, thereby enabling interactions between the user and the at least one real-world vendor.

The disclosed embodiment also relates to an apparatus for connecting real-world vendors with customers through a virtual game environment. An exemplary apparatus includes one or more processors, and one or more memories operatively coupled to at least one of the one or more processors and having instructions stored thereon that, when executed by at least one of the one or more processors, cause at least one of the one or more processors to receive, through a virtual interface, information from a user regarding a desired product or service, present, through a virtual interface, a virtual game environment based at least in part on the desired product or service, monitor the user's activity in the virtual game environment, provide, through the virtual interface, an offer to the user corresponding to the desired product or service, the offer being based at least in part on the user's activity in the virtual game environment, and provide, through the virtual interface, information identifying at least one real-world vendor corresponding to the offer, thereby enabling interactions between the user and the at least one real-world vendor.

The disclosed embodiment also relates to at least one non-transitory computer-readable medium storing exemplary computer-readable instructions that, when executed by one or more computing devices, cause at least one of the one or more computing devices to receive, through a virtual interface, information from a user regarding a desired product or service, present, through a virtual interface, a virtual game environment based at least in part on the desired product or service, monitor the user's activity in the virtual game environment, provide, through the virtual interface, an offer to the user corresponding to the desired product or service, the offer being based at least in part on the user's activity in the virtual game environment, and provide, through the virtual interface, information identifying at least one real-world vendor corresponding to the offer, thereby enabling interactions between the user and the at least one real-world vendor.

As described herein, many variations are provided. For example, the desired product or service may be associated with an event. In addition, the desired product or service may include a group of products or services in a plurality of categories associated with the event. In this scenario, the offer described above may be a first offer and the desired product or service may be a first product or service, and a second offer associated with a second product or service in the group of products or service may also be provided. The user may select either the first offer or the second offer, information may be provided that identifies the at least one real-world vendor corresponds to at least one real world vendor corresponding to the selected offer. In addition, the value of any of the offers described herein may increase or decrease based on the user's activity in the virtual game environment. For example, the value of an offer may be significantly higher if a user is very active in the virtual game environment, and may be lower if the user is not active in the virtual game environment.

### BRIEF DESCRIPTION OF THE DRAWINGS

FIG. 1 illustrates an exemplary workflow according to the disclosed embodiment.

FIG. 2 illustrates exemplary categories of products or services according to the disclosed embodiment.

FIG. 3 illustrates an exemplary discount schedule according to the disclosed embodiment.

FIG. 4 illustrates an exemplary prize voucher according to the disclosed embodiment.

FIG. 5 illustrates an exemplary customer loop and revenue trail showing interactions between a user and vendors using the platform of the disclosed embodiment.

FIG. 6 shows an exemplary flow of interactions between a user and vendors using the platform of the disclosed embodiment.

FIG. 7 illustrates an exemplary local vendor directory display sample according to the disclosed embodiment.

FIG. 8 illustrates an exemplary redemption page according to the disclosed embodiment.

FIG. 9 illustrates an exemplary Redemption Success Pop-up page according to the disclosed embodiment.

FIG. 10 illustrates an exemplary analytics page according to the disclosed embodiment.

FIG. 11 illustrates an exemplary products and services page according to the disclosed embodiment.

FIG. 12 illustrates an exemplary business presentation interface according to the disclosed embodiment.

FIG. 13 illustrates an exemplary basic information interface according to the disclosed embodiment.

FIG. 14 illustrates an exemplary item tags interface according to the disclosed embodiment.

FIG. 15 illustrates an exemplary two-dimensional (SD) representation interface according to the disclosed embodiment.

FIG. 16 illustrates an exemplary computing device according to the disclosed embodiment.

### DETAILED DESCRIPTION

The disclosed embodiment relates to methods, apparatus, and computer-readable media for connecting real-world vendors with customers through a virtual interface. In particular, the disclosed embodiment relates to helping connect vendors and advertisers with potential customers through a virtual interface on a computing device. More specifically, the disclosed embodiment enables the identification and congregation of a community of users (i.e. customers, buyers, etc.) through virtual gameplay and digital interfacing activities, and facilitates the connection of the community of users with real world servicing vendors through virtual world interactions, thereby creating a unique and customized platform connecting and integrating digital commerce with real-world commerce. According to the disclosed embodiment, any buying community can be connected with relevant vendors and service providers.

More specifically, the disclosed embodiment preferably connects users with local vendors and advertisers using an application platform, such as a gaming platform or virtual game environment, running on a computing device. The platform of the disclosed embodiment may be deployed using any known technique, such as a web-based application, a mobile app, software installed locally on a computing device, and the like. As described herein, the gaming platform or virtual game environment may be selected or designed based on information received from a user regarding any number of desired products or services.

Referring to FIG. 1, the disclosed embodiment relates to a computer-implemented method executed by one or more computing devices for connecting customers with real-world vendors through a virtual game environment. FIG. 1 illustrates an exemplary workflow 100 according to the disclosed embodiment. In step 110, information is received from a user regarding a desired product or service. In step 120, a virtual game environment is presented based at least in part on the desired product or service. In step 130, the user's activity in the virtual game environment is monitored. In step 140, an offer is provided to the user corresponding to the desired product or service. The offer is preferably based at least in part on the user's activity in the virtual game environment. In step 150, information identifying at least one real-world vendor corresponding to the offer is provided. This information enables the user to connect and interact with the at least one real-world vendor.

As described herein, many variations are provided. In addition, the value of any of the offers described herein may increase or decrease based on the user's activity in the virtual game environment. For example, the value of an offer may be significantly higher if a user is very active in the virtual game environment, and may be lower if the user is not active in the virtual game environment.

The platform may also take the form of an online social game centered on the fantasy play of planning for, and carrying out, a life event or other event, for example, a wedding, buying a house, having a baby, exterior designing and/or landscaping a home, vacationing/hospitality usage events, and the like. In this scenario, the virtual game environment is preferably based at least in part on the selected event, and products or services related to the selected event may be offered throughout the game play experience. This, the disclosed embodiment enables efficient and reliable sourcing and selection of products and services to enable the user to plan for, and carry out, the life event in the real world. In this scenario, the desired products or services may be associated with an event, and the desired products or services may include a group of products or services in a plurality of categories associated with the event.

To this end, this disclosed embodiment provides real world vendors, preferably geographically local to the user, the opportunity to give users offers and other incentives to purchase their goods and services while the users play the game. Real-world vendors can also display their company and a small selection of their products and services to the user via the game platform for use in this fantasy play. Local vendors can be identified based on a variety of criteria, for example, a GPS function on a user's mobile device, the user's address or zip code, and the like.

According to the disclosed embodiment, a user can provide information regarding their need for one or more products and/or services, and the methods of the disclosed embodiment can provide the user with one or more potential vendors or advertisements relevant to the user's needs. The vendors and advertisers are preferably associated with one or more categories of products or services to more efficiently identify their relevancy to the user's needs.

For example, if a user is planning a wedding, their needs might include a wedding dress, a caterer, a florist, a wedding cake, and the like. When the user specifies their needs, vendors and/or advertisers are presented that are relevant to those needs. FIG. 2 illustrates exemplary categories 200 for the above wedding example. As shown in FIG. 2, exemplary categories for the wedding example (i.e. when the event is a wedding, including, for example, bakeries, bands, bridal shops, caterers, churches, florists, guest accommodations, jewelers, party rentals, transportation providers, and the like. Any suitable categories can be included.

After being identified as being relevant to the user's needs, offers can be provided to the user through the virtual interface, the offers corresponding to any number of desired products or services. If an offer is relevant to the user, and the user is interested in the offer, information can also be provided that identifies at least one real-world vendor corresponding to the offer. This information enables the user to interact with the at least real-world vendor and redeem the offer.

When there are categories of products and services, they may be condensed into smaller group marques to provide a user or player with an easier choice pattern to select items and local vendors to interact with within the platform. For example, in the wedding example above and as shown in FIG. 2, MC services, DJ's, bands, soloist, duos, trios and quartets may be place in a gameplay marque “entertainment.” By interacting with vendors and/or advertisers through the platform according to the disclosed embodiment, users may take advantage of offers or discounts offered by the vendors and advertisers.

The methods of the disclosed embodiments can also utilize predictive analytics to collect data about the users or players, and provide vendors and advertisers with trends associated with the users. This information can enable the vendors and advertisers to adjust their products and/or services, as needed.

In addition, the disclosed embodiment preferably monitors a user's activity within the application platform or virtual game environment. Through the use of the methods disclosed herein, users can earn rewards associated with products and/or services offered by the identified vendors and advertisers, and the values of the offers presented to the users can be altered based on the activity of the users within the platform. For example, a player can earn discounts based on their advancement within the platform. According to this example, once the player is identified to a vendor or advertiser (i.e. via swiping a QR bar code displayed at an in-game local vendor's place of business, etc.), discounts earned by playing the game, achieving a certain level of play, or otherwise interacting with the vendor or advertiser through the platform, may be redeemed at the vendor's place of business. The discount schedule preferably has a secure Local Vendor interface and may be changed by the Local Vendor at any time. FIG. 3 illustrates an exemplary discount schedule 300. In FIG. 3, discount schedule 300 preferably identifies the vendor or service provider 305. Each relevant category 305 can be identified on discount schedule 300, for example, wedding dresses, shoes, and accessories, in headers 310. As described herein, the value of the offers can vary depending on the activity level of a user in the virtual game environment or on the platform, and the user can be identified with a level 315 having corresponding discounts based on their level (i.e. 10-30% on wedding dresses, 5-25% on shoes, or 5-50% on accessories). Of course, discount vouchers as described herein are an example of a medium for presenting offers. Other suitable formats for offers may be used.

In addition, prize vouchers, or other offers, may be given away through the platform to one or more users from time to time. For example, on a quarterly basis, the platform may award a give-a-way to players valuing as much as $250,000 in one or more prizes. These prizes can be distributed in the form of vouchers redeemable with participating vendors and advertisers for the full face value of the voucher. According to one aspect of the disclosed embodiment, the vendors may be reimbursed a percentage of the voucher value. FIG. 4 illustrates an exemplary prize voucher 400. Price voucher 400 may include a title 405, a recipient 410, an identification of a vendor or service provider of the products or services 415, and a value 420. Of course, prize vouchers as described herein are an example of a medium for presenting rewards or prizes. Other suitable formats for presenting awards may be used.

In addition, according to the disclosed embodiment, and as shown in the FIG. 5, the platform of the disclosed embodiment may be implemented via a web-based application, for example, via a social media site, such as Facebook. FIG. 5 illustrates an exemplary customer loop and revenue trail showing interactions between a user and vendors using the platform of the disclosed embodiment. In FIG. 5, a platform or virtual game environment 500, such as a Facebook game, is provided to a user 505. Within the environment, any number of microtransactions 510 may occur during gameplay. In addition, vendors 515 can be exposed within virtual game environment 500, as well as relevant advertising 520. As user 505 interacts with the virtual game environment 500, discounts 525 can be earned while market data 530 can be collected during play. When user 505 receives discounts 525 or other offers, or related vouchers 535, user 505 may interact with a vendor 540 to redeem any discounts 525 or vouchers 535, either in the real-world or through a virtual store within virtual game environment 500. This redemption may encourage user 505 or other users to increase their activity level with virtual game environment 500. As users play more, discounts and vendor exposure can increase.

The platform of the disclosed embodiment may also be implemented via a mobile application as shown in FIG. 6. FIG. 6 shows an exemplary flow of interactions between a user and vendors using the platform of the disclosed embodiment. In FIG. 6, the platform or virtual game environment can be presented in a mobile app 600, which can be downloaded or otherwise provided to a user 605. Within the environment, advertising 610 can be displayed during gameplay or at any other suitable time. In addition, vendors 615 can be exposed within virtual game environment 600. User 605 can interact with the mobile app 600 and see vendor goods 620 and make related buying choices, and shop at vendors 625, which are preferably local vendors. Discounts 630 can be earned during play, and user 605 can redeem the discounts while using the mobile app 600, either in the real-world or through a virtual store within mobile app 600. This redemption may encourage user 605 or other users to increase their activity level with the virtual game environment. As users play more, discounts and vendor exposure can increase. Mobile app 600 can be any type of mobile app or virtual game environment, for example, a social media game, such as a Facebook game 635.

While the above diagrams illustrate the use of the platform via a web-browser and mobile application, the platform may be implemented and accessed through any suitable interface on any computing device. In addition, users may earn rewards as described above while using one version of the platform of the disclosed embodiment and redeem them in another, and vice versa. The interfaces through which the user accesses the platform are preferably substantively interchangeable, and a user is not limited to using the methods of the disclosed embodiment through a single interface.

While the above describes exemplary platforms of the disclosed embodiment from the perspective of a user or player, the platforms of the disclosed embodiment are also utilized extensively by vendors and advertisers. Specifically, in order to provide a robust offering of vendors and advertisers to users, the platforms of the disclosed embodiment preferably include a large number of vendors and advertisers.

For this reason, as aspect of the disclosed embodiment relates to establishing relationships with vendors and advertisers to associate their goods and services with the platforms described herein. For example, if a vendor wishes to have his products shown to users via an interface on the disclosed platforms, the vendor may be required to register with the systems of the disclosed embodiment, and pay a fee for the service provided, for example, a subscription fee (i.e. on a monthly basis). Each vendor may also be required to subscribe for a predetermined period of time (i.e. one year, two years, etc.). While subscribed to the services of the platforms of the disclosed embodiment, each vendor will preferably participate in the user features described above, including, for example, the prize voucher redemption feature and the 2) achieved level discount schedule.

After subscribing or otherwise establishing placement with the platforms of the disclosed embodiment, vendors will preferably be provided with one or more displays on the platform, as shown in the diagram below, with reference to the wedding example. These features provide substantial exposure of the vendor to users that are using the platform of the disclosed embodiment, and drive users to those vendors. FIG. 7 illustrates an exemplary local vendor directory display sample 700. Display sample 700 preferably includes a header identifying the vendor 705, an image 715 associated with vendor 705, such as a logo or the like, a description 710 of vendor 705 as well as the products or services vendor 705 provides, and additional images or descriptions 720 of exemplary products or services offered by vendor 705.

Features of the disclosed embodiment as they relate to vendors and advertisers are described in detail below.

From the vendor perspective, the platforms of the disclosed embodiments allow vendors the ability to manage their accounts associated with the platforms as well as process game-related functionality, such as Reward Points and Vouchers. Exemplary platforms preferably include browser-based user interfaces to assist Vendors with, for example, Reward Point and Voucher Code Redemption, Analytics Viewer, Offering Overview, Reward Point Trade-in Scheduling, Asset Upload Assistant, In-Game Business Presentation, Redemption Page and Redemption Success, and the like.

The platforms of the disclosed embodiment also preferably include a Redemption Page for vendor use, which is an interface in which Vendors can validate and redeem various codes provided by customers. FIG. 8 illustrates an exemplary redemption page 800. Redemption page 800 can include a variety of information such as a field to enter a redemption code 805, a frame 810 confirming that redemption code 805 was correct, a date field 815 displaying the date redemption code 805 was redeemed, and details of the corresponding offer. The offer may include the number of points 820 that were redeemed (i.e. 1000), the value 825 of the discount (i.e. 10%), the minimum purchase required 830 (i.e. $200), any other conditions 835 (i.e. seasonal flowers), and the like.

If redemption is successful, a redemption success confirmation may be displayed. FIG. 9 illustrates an exemplary Redemption Success Pop-up 900. Redemption Success Pop-up 900 preferably pops-up over redemption page 800. Redemption Success Pop-up 900 preferably includes a notification frame 900 indicating that the redemption was successful, a vendor identification 905, a user identification 910, a confirmation code 915, and the like.

Referring to the above diagrams, and as described above, the screen generally includes a Page Title (“Redeem Vouchers and Reward Points”), a Redemption Code Entry, and a “Redemption Code” label, which may include a code entry text field and a “Submit” button. After entering a code, the vendor user may press “Enter” while the entry field has focus or press the “Submit” button to validate the entered code. While the webpage is awaiting a response from the server, the “activity” image becomes visible and animates to show that the system is working This is preferably merely a validity check and does not “consume” the code.

Upon server response, the “activity” image disappears, and the validity of the code is noted to the user. If the code is valid, the “Redemption Details” panel appears beneath the validity message. In this scenario, the panel preferably displays the date of redemption, a table displaying the voucher value or rewards points discount offer, text informing the Vendor that they have not redeemed the code yet and that they must press “Redeem” as acknowledgement of code use, a “Redeem” button, and “Cancel” button. Of course any other suitable information may also be displayed.

If the user presses the “Redeem” button, all buttons on the Redemption page preferably become disabled, a “Processing” pop-up preferably appears indicating that the code is being redeemed, and upon successful redemption, a “Success” pop-up preferably appears showing, for example, the redeemed code, the vendor ID, the user ID, a transaction confirmation code, and the like. In addition to the in-game events, notifications can be sent to the inboxes of users associated with the user account, users associated with the vendor ID, including, for example, Managers and Administrators.

Analytics Page

The platforms of the disclosed embodiments also preferably include an analytics page that presents a vendor user with a set of data related to their account. FIG. 10 illustrates an exemplary analytics page. The types of data that may be displayed here include, for example:

Impressions 1005 (total, monthly average, last 30 days, delta from average). This can include, for example, offering views, offering inspections, vendor inspections, and the like.

Dreambook Inclusions 1010 (total, monthly average, last 30 days, delta from average). This can include, for example, information regarding customer selections (i.e. Dreambook inclusions), proposals associated with customer selections (i.e. Dreambook proposals), items commented, and the like. The term “Dreambook” generally refers to a listing of gallery of choices presented to users and the corresponding selections made by those users.

Redemptions & Codes 1015. This can include, for example, reward points 1020 (i.e. player spent, redeemed, outstanding, etc.), reward point codes 1025 (i.e. generated, redeemed, outstanding, etc.), and the like.

Products & Services

The platforms of the disclosed embodiments also preferably include a products and services interface in which vendors can add and modify information about their business including, for example, upload their business image (logo, storefront, etc.), enter/edit their business description as it appears to players in game, upload their product images, enter/edit their product descriptions and pricing information, tag their products (step-by-step process using predefined tags), set/qualify their Rewards Point discounts, and the like. FIG. 11 illustrates an exemplary products and services page 1100.

On products and services page 1100, thumbnail images 1105 may be displayed to give the Vendor a quick overview of their currently presented offerings. Any active offering can be shown by their image thumbnail; empty offering slots can be shown with a question mark. Clicking an active slot preferably jumps the vendor user to the page bookmark below that details the item offering, and clicking an empty slot preferably starts the New Item Entry process. A business view frame 1110 preferably includes any uploaded business images and related descriptions. Business name and location can be drawn from the business database. Links in the section title bar provide navigation, as needed.

The Rewards Points Offers List 1115 portion of products and services page 1100 preferably allows users to view and edit their Rewards Points Offers. Features of this portion of the page include, for example, offer slots equal to the number of entries in the schedule, with the offer slots being collapsed by default. The collapsed slot view indicates, for example, point value, text description of the offer as it is presented to players (user editable fields are shown in bold, for example), and the like. Expanding an offer slot preferably shows discounts (i.e. a percentage of price), minimum purchase levels (i.e. value, default currency, etc.), qualifiers (i.e. character-limited, obscenity-filtered text field that permits the user to set qualifiers on their discount offer), characters remaining labels, reserved error message spaces, an update button (i.e. disabled until one or more of the fields is edited), a cancel button (i.e. discards any changes and collapses the slot), and the like. Of course, these features are not all required, and additional features may be included.

The Active Offer Display portion 1120 of products and services page 1100 preferably gives a summary view of the item as entered by the vendor. The section title may display the name of the item, any product code, the price, and the like. In the event that the price is not set in US Dollars, an approximated conversion may be presented to inform the Vendor of what the cost of the item will be for gameplay purposes. Links in the section title bar preferably provide navigation including, for example, edit (i.e. opens the New Item interface with the fields pre-filled with existing content), top (i.e. returns the user to the top of the screen), and the like.

The Empty Offer Display 1125 portion of the products and services page preferably reminds the vendor user of empty offer slots, and provides a section bar for the slot though no summary content is available to be provided. The section title may display “Available!”, for example, in red. Links in the section title bar provide navigation including, for example, add (i.e. opens the New Item interface), top (returns the user to the top of the screen), and the like.

Business Presentation

In addition, the disclosed embodiment preferably includes a business presentation interface. FIG. 12 illustrates an exemplary business presentation interface 1200. The business presentation interface 1200 preferably includes a Business Description 1205, which may provide a textual explanation why the user is being requested to enter a business description, an obscenity-filtered, character limited description field for text entry, and the like. The business presentation interface 1200 may also include an image 1210, such as a thumbnail to show the current image, if any, an update Image button that allows the user to browse their computer for an image, an Image Guidelines Info Box (i.e. provides bullet-point data regarding requirements and use of the image) and the like. The business presentation interface 1200 may further include a error messaging area, page buttons (i.e. Cancel, which discards any changes during the item edit session and returns to the Offering Overview, Next, which validates submitted data and proceeds, if possible, etc.), and the like. In the event of an error, the appropriate location(s) can be designated with an icon and error text. The screen preferably focuses view on the top-most error first.

Basic Information

FIG. 13 illustrates an exemplary basic information interface 1300. The Basic Product Information interface 1300 preferably provides fields 1305 for information entry, including, for example, Name 1310, Product code 1315, Price/Value 1320, Currency 1325, Estimated prices in other currencies 1330, a Description 1335, an Image 1340 (i.e. a thumbnail to show the current image, if any), an update Image button 1345 that allows the user to browse their computer for an image, an Image Guidelines Info Box 1350 (i.e. provides bullet-point data regarding requirements and use of the image), an Error messaging area, Page Buttons (i.e. cancel, which discards any changes during the item edit session and returns to the Offering Overview, next, which validates submitted data and proceeds, if possible, etc.), and the like. In the event of an error, the appropriate location(s) is/are designated with an icon and error text. The screen preferably focuses the view on the top-most error first.

Item Tags

FIG. 14 illustrates an exemplary item tags interface 1400. The item tags interface 1400 preferably includes, for example, an Image Display 1405, which is optimally positioned at the top of the screen regardless of scrolling done in the browser, Item Tags 1410, which allow users to select categories, thereby populating the page with the appropriate tag list, and a number of fields for the Vendor to tag the item. Any field that has not been set may be marked, for example, with a yellow “caution” icon. Item tags may be different for each offering category and will change based on the category selected. This interface may also include Page Buttons (i.e. Cancel, which discards any changes during the item edit session and returns to the Offering Overview, Next, which validates submitted data and proceeds, if possible, etc.), and the like. In the event of an error, the appropriate location(s) can be designated with an icon and error text. The screen preferably focuses the view on the top-most error first. For fields that may be left empty, such as checkbox lists, a pop-up may be used to confirm that the user really wants to proceed without filling in those fields.

2D Representation

FIG. 15 illustrates an exemplary two-dimensional (SD) representation interface 1500. The 2D representation interface 1500 enables a vendor to select a representational art asset 1505, which may be used to represent actual asset images in product ‘photos’. The view is preferably similar to the data presented in the Active Offering Slot. Pending aesthetic review, it is possible that these two could be merged into a single panel for use in both locations. A 2D List Header 1510 can be used to inform the user that the default display is filtered based on the provided criteria to make the selection process easier. Links can also be used to allow the user to switch between filtered (“filtered”) and unfiltered (“show all”). This interface also preferably includes a List that is populated with 2D items that the developers have tagged similarly to the tags noted by the vendor for the item in question. This interface may also include Page Buttons, such as cancel, which discards any changes during the item edit session and returns to the Offering Overview, next, which validates submitted data and proceeds, if possible, etc. In the event that an item is not selected and the Next button is pressed, the List Header is preferably updated to display “Please Select a 2D Representation” in red. Successfully clicking Next may return the user to the Offerings Overview page.

Computer Implementation

The methods of the disclosed embodiment are preferably computer-implemented and executed by one or more computing devices. In addition, the disclosed embodiment relates to apparatus comprising one or more processors and one or more memories operatively coupled to at least one of the one or more processors. The memories of an exemplary apparatus have instructions stored thereon that, when executed by at least one of the one or more processors, cause at least one of the one or more processors to carry out the steps of the exemplary methods. The disclosed embodiment further relates to non-transitory computer-readable media storing computer-readable instructions that, when executed by at least one of one or more computing devices, cause at least one of the one or more computing devices to carry out the steps of the exemplary methods.

The embodiments described herein may be implemented with any suitable hardware and/or software configuration, including, for example, modules executed on computing devices such as computing device 1610 of FIG. 16. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 1610 has one or more processing device 1611 designed to process instructions, for example computer readable instructions (i.e., code) stored on a storage device 1613. By processing instructions, processing device 1611 may perform the steps set forth in the methods described herein. Storage device 1613 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 1610 additionally has memory 1612, an input controller 1616, and an output controller 1615. A bus 1614 operatively couples components of computing device 1610, including processor 1611, memory 1612, storage device 1613, input controller 1616, output controller 1615, and any other devices (e.g., network controllers, sound controllers, etc.). Output controller 1615 may be operatively coupled (e.g., via a wired or wireless connection) to a display device 1620 (e.g., a monitor, television, mobile device screen, touch-display, etc.) In such a fashion that output controller 1615 can transform the display on display device 1620 (e.g., in response to modules executed). Input controller 1616 may be operatively coupled (e.g., via a wired or wireless connection) to input device 1630 (e.g., mouse, keyboard, touch-pad, scroll-ball, touch-display, etc.) In such a fashion that input can be received from a user (e.g., a user may input with an input device 1630 a dig ticket).

Of course, FIG. 16 illustrates computing device 1610, display device 1620, and input device 1630 as separate devices for ease of identification only. Computing device 1610, display device 1620, and input device 1630 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 1610 may be one or more servers, for example a farm of networked servers, a clustered server environment, or a cloud network of computing devices.

While systems and methods are described herein by way of example and embodiments, those skilled in the art recognize that the disclosed embodiment is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A computer-implemented method executed by one or more computing devices for connecting customers with real-world vendors through a virtual game environment, the method comprising:
receiving, by at least one of the one or more computer devices, through a virtual interface, information from a user regarding a desired product or service;
presenting, by at least one of the one or more computer devices, through a virtual interface, a virtual game environment based at least in part on the desired product or service;
monitoring, by at least one of the one or more computer devices, the user's activity in the virtual game environment;
providing, by at least one of the one or more computer devices, through the virtual interface, an offer to the user corresponding to the desired product or service, the offer being based at least in part on the user's activity in the virtual game environment; and
providing, by at least one of the one or more computer devices, through the virtual interface, information identifying at least one real-world vendor corresponding to the offer, thereby enabling interactions between the user and the at least one real-world vendor.

2. The method of claim 1, wherein the desired product or service is associated with an event.

3. The method of claim 2, wherein the desired product or service includes a group of products or services in a plurality of categories associated with the event.

4. The method of claim 3, wherein the offer is a first offer, wherein the desired product or service is a first product or service, and wherein the method further comprises providing a second offer associated with a second product or service in the group of products or service.

5. The method of claim 4, further comprising receiving a selection of either the first offer or the second offer, and wherein the information identifying the at least one real-world vendor corresponds to at least one real world vendor corresponding to the selected offer.

6. The method of claim 1, wherein offer has a value, and wherein the value of the offer increases based on the user's activity in the virtual game environment.

7. An apparatus for connecting real-world vendors with customers through a virtual game environment, the apparatus comprising:
one or more processors; and
one or more memories operatively coupled to at least one of the one or more processors and having instructions stored thereon that, when executed by at least one of the one or more processors, cause at least one of the one or more processors to:
receive, through a virtual interface, information from a user regarding a desired product or service;
present, through a virtual interface, a virtual game environment based at least in part on the desired product or service;
monitor the user's activity in the virtual game environment;
provide, through the virtual interface, an offer to the user corresponding to the desired product or service, the offer being based at least in part on the user's activity in the virtual game environment; and
provide, through the virtual interface, information identifying at least one real-world vendor corresponding to the offer, thereby enabling interactions between the user and the at least one real-world vendor.

8. The apparatus of claim 7, wherein the desired product or service is associated with an event.

9. The apparatus of claim 8, wherein the desired product or service includes a group of products or services in a plurality of categories associated with the event.

10. The apparatus of claim 9, wherein the offer is a first offer, wherein the desired product or service is a first product or service, and wherein at least one of the one or more memories has further instructions stored thereon that, when executed by at least one of the one or more processors, cause at least one of the one or more processors to provide a second offer associated with a second product or service in the group of products or service.

11. The apparatus of claim 10, wherein at least one of the one or more memories has further instructions stored thereon that, when executed by at least one of the one or more processors, cause at least one of the one or more processors to receive a selection of either the first offer or the second offer, and wherein the information identifying the at least one real-world vendor corresponds to at least one real world vendor corresponding to the selected offer.

12. The apparatus of claim 7, wherein offer has a value, and wherein the value of the offer increases based on the user's activity in the virtual game environment.

13. At least one non-transitory computer-readable medium storing computer-readable instructions that, when executed by one or more computing devices, cause at least one of the one or more computing devices to:
receive, through a virtual interface, information from a user regarding a desired product or service;
present, through a virtual interface, a virtual game environment based at least in part on the desired product or service;
monitor the user's activity in the virtual game environment;
provide, through the virtual interface, an offer to the user corresponding to the desired product or service, the offer being based at least in part on the user's activity in the virtual game environment; and
provide, through the virtual interface, information identifying at least one real-world vendor corresponding to the offer, thereby enabling interactions between the user and the at least one real-world vendor.

14. The at least one non-transitory computer-readable medium of claim 13, wherein the desired product or service is associated with an event.

15. The at least one non-transitory computer-readable medium of claim 14, wherein the desired product or service includes a group of products or services in a plurality of categories associated with the event.

16. The at least one non-transitory computer-readable medium of claim 15, wherein the offer is a first offer, wherein the desired product or service is a first product or service, and further storing instructions that, when executed by one or more computing devices, cause at least one of the one or more computing devices to provide a second offer associated with a second product or service in the group of products or service.

17. The at least one non-transitory computer-readable medium of claim 16, further storing instructions that, when executed by one or more computing devices, cause at least one of the one or more computing devices to receive a selection of either the first offer or the second offer, and wherein the information identifying the at least one real-world vendor corresponds to at least one real world vendor corresponding to the selected offer.

18. The at least one non-transitory computer-readable medium of claim 13, wherein offer has a value, and wherein the value of the offer increases based on the user's activity in the virtual game environment.
